(19) United States
(12) Patent Application Publication
(10) Pub. No.: US 2013/0282258 A1
(43) Pub. Date: Oct. 24, 2013

(54) METHOD FOR GENERATING DOWN FORCE BY VEHICLES OPERATED BY INTERNAL COMBUSTION ENGINES

(71) Applicant: Peter Schoeggl, Hitzendorf (AT)

(72) Inventor: Peter Schoeggl, Hitzendorf (AT)

(73) Assignee: AVL LIST GMBH, Hitzendorf (AT)

(21) Appl. No.: 13/884,957

(22) PCT Filed: Nov. 9, 2011
(86) PCT No.: PCT/EP2011/069699

§ 371 Date: Jul. 5, 2013

(30) Foreign Application Priority Data
Nov. 11, 2010 (AT) A 1856/2010

(51) Int. Cl. F02D 45/00

(52) U.S. Cl. CPC F02D 45/00
USPC 701/102

(57) ABSTRACT

A method which generates downforce in a vehicle powered by an internal combustion engine, based on feeding exhaust gas from the internal combustion engine into at least one area of the vehicle body suitable for increasing downforce.

### CROSS-REFERENCE TO RELATED APPLICATIONS

The present application is a National Stage Application of PCT International Application No. PCT/EP2011/069699 (filed on Nov. 9, 2011), under 35 U.S.C. §371, which claims priority to Austrian Patent Application No. A 1856/2010 (filed on Nov. 11, 2010), which are each hereby incorporated by reference in their complete respective entireties.

### TECHNICAL FIELD

The invention relates to a method for generating downforce in vehicles powered by internal combustion engines, especially racing vehicles and sports vehicles, with a means for generating downforce, which is based on feeding exhaust gas from the internal combustion engine into at least one area of the vehicle body suitable for increasing downforce.

### BACKGROUND

A method and apparatus for generating downforce at the underbody of racing and sports vehicles is known from DE 41 10 750 A1.

In racing and sports vehicles there occur accelerations, decelerations and radial accelerations in considerable excess of 1 g (=gravitational constant). This is only possible if the limits of grip between tires and road surface are increased by aerodynamic means. A strong downforce is generated on the vehicle body. Front spoilers, rear spoilers and a specially designed shape of the vehicle body are provided for this purpose. In this respect the design of the vehicle underbody plays a dominant role. The aim is to accelerate the air flowing beneath the underbody as much as possible. The higher the flow velocity of the air the higher will be the suction force in accordance with Bernoulli's law and the downforce exerted on the vehicle underbody. To achieve maximum acceleration of the underbody airflow modern racing vehicles make use of the kinetic energy of exhaust gases. The underbody is bent upwards at the rear of the vehicle and is usually laterally shielded by perpendicular aerodynamic air baffles, possibly even divided in the middle. In this way a diffuser is created for the air flowing along the underside of the vehicle. Into this diffuser zone the ends of the exhaust pipes are introduced with the exhaust jet pointing horizontally to the rear. The exhaust gases emitted with high velocity exert a suction force on the air beneath the underbody. The air velocity is thereby increased, as is the suction force on the underbody and the downforce on the vehicle.

It is of disadvantage that the downforce induced by the exhaust flow is heavily dependent on engine rpm. If the speed is decreased when driving through a bend this will affect the exhaust-induced downforce which will also decrease.

### SUMMARY

It is an object of the present invention to avoid this disadvantage and to increase downforce especially in such sections of the road which are passed at low rpm.

In accordance with the invention this object is achieved by providing that the air ratio λ of the internal combustion engine is varied—preferably depending on road curvature—, such that in sections of the road where an increase of downforce is required, the internal combustion engine is in lean operation, preferably at an air ratio λ of at least 1.2, and more preferably at least 1.3.

The internal combustion engine of a racing vehicle, for instance a formula-I racer, which is usually operated stoichiometrically or on a rich A/F mixture, is thus leaned down in sections of the track where increased downforce is required, with the leaning effect preferably attained by increasing air throughput. Increased air throughput causes an increase of emitted exhaust gas and thus an increased flow velocity of the air between underbody and road, which will lead to a pronounced increase in downforce.

The air ratio λ may be varied by means of a control element, situated for instance on the steering wheel. It is also possible that the air ratio is varied by the driver in an indirect way, for instance depending on the gear chosen and/or the engine speed of the internal combustion engine and/or the angle of the accelerator or brake pedal.

The increase of the air ratio λ may be limited to a defined period of time, the length of the period being fixed or set by the driver to a freely chosen value. Alternatively or additionally it will also be possible that lean operation is automatically ended when exiting the bend, for instance when the lateral forces or the steering angle drop beneath a limiting value.

In order to ensure sufficient downforce in every situation of the vehicle it may further be provided that the actual downforce is monitored by sensors in the vehicle and that the air ratio is increased when the actual downforce drops below a certain target value.

In the context of the present invention it is further proposed that the course layout, including sections where an increase in downforce is required, is stored in an electronic database, with the vehicle preferably being furnished with a device for position determination by means of which the current position of the vehicle as referred to the stored course layout is determined.

In this way it is possible to identify areas where increased downforce is required for every position of the racing vehicle on the race course.

It may further be provided that a target value for downforce and propulsion power is determined and stored for every point of the stored course layout, with a target value for the air ratio being determined and stored for every point of the race course, which is preferably based on the target values for downforce and propulsion power.

In a further variant of the invention it may be provided that the actual air ratio of the internal combustion engine for every point of the race course is controlled and adjusted in accordance with the stored target value of the air ratio. In this way the optimum downforce for the vehicle may be automatically generated for every actual position of the vehicle—without manual intervention of the driver.

### DRAWINGS

The invention will now be described in more detail with reference to the enclosed drawings. There are illustrated in:

FIGS. 1 to 3 illustrate diverse arrangements for increasing downforce in a vehicle in accordance with the method of the invention.

### DESCRIPTION

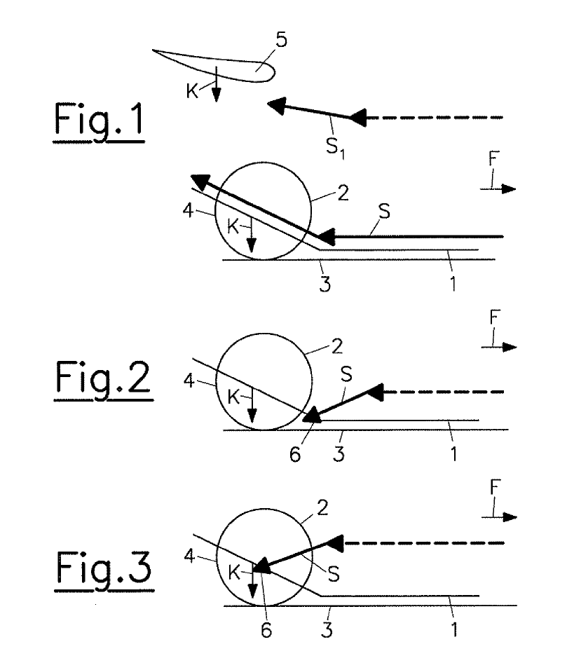

FIGS. 1 to 3 schematically illustrate the underbody 1 and a rear wheel 2 of a racing vehicle. As can be observed the underbody has an upward slope in the area of the rear wheel 2—as seen against the direction of motion F—and forms a diffuser 4 together with the ground 3. Arrows S indicate flows of exhaust gas, which are introduced at various points of a downforce generating device to increase downforce K. The diffuser 4 implements one downforce generating device. Another downforce generating device is realized by the rear spoiler 5. As can be seen from FIG. 1, to increase downforce exhaust gas is fed to the lower side of the rear spoiler 5 as indicated by arrow S1. Exhaust gas may also be introduced along the top side of the underbody 1.

In FIG. 2, the underbody 1 has an outflow opening 6 in the transition area to the diffuser 4, through which exhaust gas is fed into the narrow front section of the diffuser 4.

FIG. 3 illustrates a variant in which the outflow opening 6 is disposed inside the diffuser 4. The exhaust gas is blown directly into the diffuser 4.

In all variants illustrated the downforce K acting on the rear wheels 2 depends on the velocity of the exhaust gas flow S, S1.

The method of the invention proposes lean operation of the internal combustion engine of the racing vehicle in road sections where increased downforce is required, lean operation for instance meaning an air ratio of λ=1.2 or more, and increased air throughput through the internal combustion engine. Increased air throughput causes an increase in exhaust gas volume and exhaust gas velocity with concomitant increase in downforces K.

A time-limited increase of the air ratio may be initiated directly by the driver actuating a button or control at the steering wheel. The duration of the increase could depend on a timer. It is furthermore conceivable that the duration of the increase in air ratio λ depends on the readings of an acceleration sensor or on the steering angle, such that the air ratio can be reduced to its initial lower value when exiting a curve. It is furthermore possible that the driver indirectly changes the air ratio if it is made dependent on the choice of gear and/or engine speed and/or brake or accelerator pedal angle, such that shifting to a lower gear will automatically increase the air ratio for a certain length of time.

It is of particular advantage if sections of the course layout where an increased downforce is required are stored in an electronic database. In this case the vehicle is provided with a position detection device, which determines the current position of the vehicle along the race course. When the vehicle enters a section of the course which requires increased downforce K, the engine is automatically operated in lean mode, which will very quickly build up additional downforces K. These additional downforces K can at least partially compensate a loss of downforce due to curve-dependent reduction of rpm of the internal combustion engine, which in turn will permit taking the curve at higher velocity.

1-11. (canceled)

12. A method to generate downforce in a vehicle powered by an internal combustion engine, the method comprising:
feeding exhaust gas from the internal combustion engine into at least one area of the vehicle body depending on curvature of a road upon which the vehicle is traveling; and
varying an air ratio of the internal combustion engine such that in sections of the road which require increased downforce the internal combustion engine is operated in a lean mode.

13. The method of claim 12, wherein the air ratio λ is at least 1.2.

14. The method of claim 12, wherein preferably the air ratio is at least 1.3.

15. The method of claim 12, wherein the air ratio is manually increased directly by the driver.

16. The method of claim 12, wherein the air ratio is manually increased indirectly by the driver.

17. The method of claim 12, wherein the air ratio is varied depending on a gear chosen.

18. The method of claim 12, wherein the air ratio is varied depending on a gear chosen and the rpm of the internal combustion engine.

19. The method of claim 12, wherein the air ratio is varied depending on a gear chosen and/or the rpm of the internal combustion engine

20. The method of claim 12, wherein the air ratio is increased for a defined length of time.

21. The method of claim 12, wherein a lean operational mode is ended when measured lateral forces and a determined steering angle are below a defined limiting value.

22. The method of claim 12, wherein a lean operational mode is ended when measured lateral forces is below a defined limiting value.

23. The method of claim 12, wherein a lean operational mode is ended when a determined steering angle is below a defined limiting value.

24. The method of claim 12, wherein:
a current downforce is measured by sensors in the vehicle; and
the air ratio is increased if the measured downforce is below a downforce target value.

25. The method of claim 12, wherein a course layout of the road is stored in an electronic database.

26. The method of claim 25, wherein the vehicle is furnished with a position detection device by which a current position of the vehicle is detected in relation to the stored course layout.

27. The method of claim 26, wherein for each point of the stored course layout a target value for the downforce and the propulsion force is determined and stored.

28. The method of claim 27, wherein for each point of the course layout a target value for the air ratio is determined and stored.

29. The method of claim 28, wherein the target value for the air ratio is based on the target values for downforce and propulsion force for each point.

30. The method of claim 29, wherein for each point of the stored course layout the current air ratio is adjusted to match the stored air ratio target value.

31. A method, comprising:
feeding exhaust gas an internal combustion engine of a vehicle into at least one area of the vehicle body depending on curvature of a road upon which the vehicle is traveling; and
varying an air ratio of the internal combustion engine such that in sections of the road which require increased downforce the internal combustion engine is operated in a lean mode.
